(19) United States
(12) Patent Application Publication
(10) Pub. No.: US 2025/0137883 A1
(43) Pub. Date: May 1, 2025

(54) ENGINE OIL SYSTEM HEALTH MONITORING USING OIL LEVEL SENSOR

(71) Applicant: Progress Rail Locomotive Inc., LaGrange, IL (US)

(72) Inventors: Adarsh G. NAIR, Naperville, IL (US); Christopher B. HILL, Riverside, IL (US)

(73) Assignee: Progress Rail Locomotive Inc., LaGrange, IL (US)

(21) Appl. No.: 18/499,453

(22) Filed: Nov. 1, 2023

(51) Int. Cl. G01M 15/04; F01M 11/10; F01M 11/12; G01F 23/263

(52) U.S. Cl. CPC G01M 15/042; F01M 11/12; G01F 23/263; F01M 2011/1426; F01M 2011/1446; F01M 2011/1473

(57) ABSTRACT

A method for determining engine oil system health includes determining an oil level in an engine oil sump of an engine, determining an oil consumption rate of the engine based on a current oil volume and a time at which the oil was last replenished, determining a remaining useful oil volume based on the oil consumption rate and duty cycle data of the engine, and generating an alert in response to the oil consumption rate being greater than a predetermined threshold, the alert comprising a command to a controller associated with the engine to cause the engine to perform an action.

### TECHNICAL FIELD

The present disclosure relates generally engine oil systems, and, more particularly, to systems and method for monitoring the fill level, change intervals, and life expectancy of oil volume in an engine oil system.

### BACKGROUND

Oil-based lubrication systems are ubiquitous in modern industrial and consumer machines, including automobiles, trucks, construction equipment, rail vehicles, etc. Internal combustion engines utilize an oil-based lubrication system that typically includes a pump which transports oil to various components requiring lubrication, and a sump which collects oil that flows back from those components. Typically, oil must be changed at predetermined intervals as oil breaks down or otherwise become less effective. Such predetermined intervals may be expressed in various ways depending on the particular application of the engine. For example, in automobiles, oil change intervals are typically expressed in terms of miles driven, whereas in stationary machinery, oil change intervals may be expressed in terms of operating hours and/or total power output. In rail applications, oil change intervals may be based on any of the foregoing, or a combination thereof. In addition to oil changes, engines may require periodic replenishing (i.e. topping off) of oil to replace oil lost due to normal engine operation.

In order to predict oil change intervals, schedule maintenance, and/or reduce downtime, various forms of oil monitoring in internal combustion engines have been proposed. U.S. Pat. No. 6,253,601 to Wang et al. (“the '601 publication”) describes a system and method for indicating when the oil of an engine needs to be changed. The system includes measuring engine parameters such as engine temperature, fueling rate, engine speed, and engine load. At timed intervals, soot generation, viscosity increase, and total base number (TBN) depletion are estimated to determine whether the oil needs changing. The system is supplemented with real time sensors such as an oil level sensor, a soot sensor, and a viscosity sensor which provide a backup for the calculation of estimates. The system and method also can correct for the accumulation of oil consumption caused by evaporation of oil or leakage of oil.

The '601 patent describes a relatively complex algorithm for determining oil health based on soot, viscosity, and TBN, while only utilizing the oil level sensor to detect catastrophic conditions. The devices, systems, and methods of the present disclosure reduce the complexity of oil health measurement described in the '601 patent and/or address other problems in the art. The scope of the current disclosure, however, is defined by the attached claims, and not by the ability to solve any specific problem.

### SUMMARY

In one aspect, the present invention is directed to a method for determining engine oil system health, the method comprising determining an oil level in an engine oil sump of an engine, determining an oil consumption rate of the engine based on a current oil volume and a time at which the oil was last replenished, determining a remaining useful oil volume based on the oil consumption rate and duty cycle data of the engine, and generating an alert in response to the oil consumption rate being greater than a predetermined threshold, the alert comprising a command to a controller associated with the engine to cause the engine to perform an action.

In another aspect, the present invention is directed to a system for monitoring engine system oil health, the system comprising an oil sump of an engine, an oil level sensor for determining oil level in the oil sump, and a controller configured to determine an oil fill schedule based at least partially on the oil level, wherein the oil fill schedule includes a date or range of dates at which oil in the oil sump should be replenished.

In still another aspect, the present invention is directed to a method for determining an estimated fill schedule for an engine oil system, the method including determining an oil level in an engine sump, determining an oil volume in the engine sump based on the oil level, determining an oil consumption rate of the engine based on the oil volume, and determining an estimated fill schedule for the oil based on the oil consumption rate.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic view of an engine oil system, according to aspects of the disclosure.

FIG. 2 is a block diagram of a control system of the engine oil system of FIG. 1.

FIG. 3 is a flowchart depicting an exemplary method for determining oil heath of an engine oil system.

FIG. 4 is a graph depicting oil volume in an oil sump of the engine oil system over time.

FIG. 5 is a graph depicting oil consumption of an engine against power output.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about.” “substantially,” “generally,” and “approximately” are used to indicate a possible variation of ±10% in the stated value or characteristic.

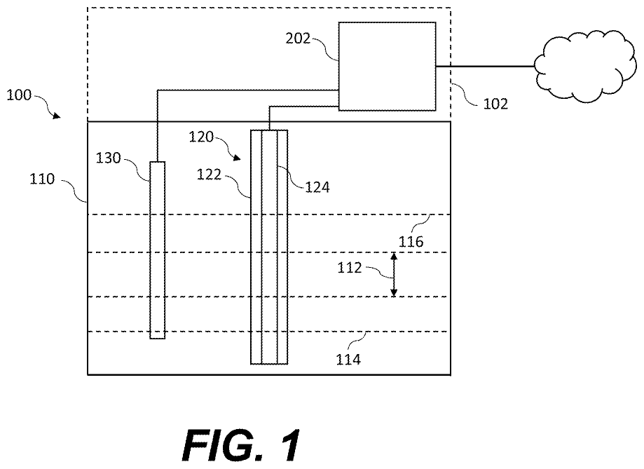

FIG. 1 shows an engine oil monitoring system 100 including an oil sump 110 (which may include or be part of an oil pan of an engine 102), an oil level sensor 120, and a controller 202. In some aspects, engine 102 may be an internal combustion engine used in a machine, such as a rail locomotive. Oil sump 110 may be attached to the bottom of engine 102 (e.g., below the crankshaft) such that oil from the various engine components drains into oil sump 110. From oil sump 110, the oil can be recirculated to various engine components (not shown), such as bearings, pistons, valves, crankshaft components, camshaft components, fuel injectors, etc., by an oil pump (not shown).

Oil level sensor 120 is configured to detect a level of oil in oil sump 110. In particular, oil level sensor 120 may be configured to determine the oil level relative to an ideal range 112, a low oil level 114, and a high oil level 116. In some aspects, oil level sensor 120 may be a capacitive liquid level sensor which includes a pair of electrodes 122, 124 spaced apart from one another to form a capacitor. Changes in the oil level in the oil sump 110 causes a change in the capacitance between electrodes 122, 124. Oil level sensor 120 generates an electrical output signal (e.g., a voltage signal) based on the capacitance between electrodes 122, 124. Thus, the electrical output signal from oil level sensor 120 varies based on the level of oil in oil sump 110. Though oil level sensor 120 is shown and described as a capacitive liquid level sensor, oil level sensor 120 may be any type of liquid level sensor, such as a float gauge, ultrasonic liquid level sensor, etc. that generates an electrical signal based on the oil level in oil sump 110.

In some aspects, engine oil monitoring system 100 may further include an oil temperature sensor 130 to detect temperature of the oil within oil sump 110. Temperature sensor 130 may be any suitable temperature-measuring device such as a thermocouple, thermistor, etc. In one or more embodiments, temperature sensor 130 may be part of the oil level sensor 120 and/or within the same sensor housing as the level sensor 120.

Oil level sensor 120 and temperature sensor 130 communicate with controller 202. In particular, each of oil level sensor 120 and temperature sensor 130 transmits an electrical signal to controller 202 indicative of oil level and temperature, respectively, of the oil in oil sump 110.

Controller 202 may be provided on the same machine (e.g. a locomotive) as engine oil monitoring system 100, at a remote site, or components of controller 202 may be divided between the machine and a remote site. In aspects in which controller 202 is provided on the same machine as engine oil monitoring system 100, controller 202 may be in communication with a remote site via a network 150. Network 150 may include, for example a cloud-based network. Controller 202 may include or be a component of an electronic control module (ECM) of a control system 200 that controls engine 102.

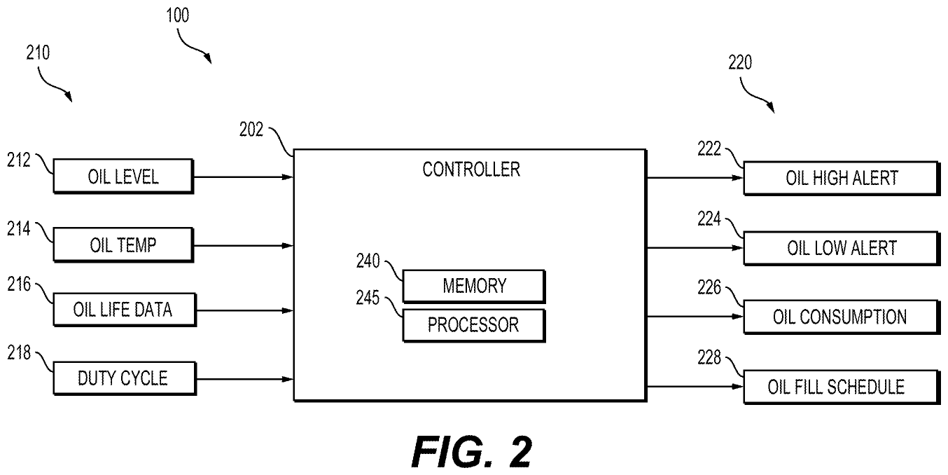

As shown in FIG. 2, controller 202 of engine oil monitoring system 100 is configured for receiving various inputs 210 from various sources, and for providing outputs 220. Inputs 210 into controller 202 include oil level data 212 received from oil level sensor 120, oil temperature data 214 received from temperature sensor 130, oil life data 216, and duty cycle data 218. Oil level data 212 may include the current and/or historical level of oil within oil sump 110, as measured by oil level sensor 120. Oil temperature data 214 may include the current and/or historical temperature of oil within oil sump 110, as measured by oil temperature sensor 130. Oil life data 216 may include data related to the life and/or change intervals of oil in oil sump 110. For example, oil life data 216 may include a time at which the oil in oil sump 110 was last changed, and/or a time at which the oil in oil sump 110 was last replenished (i.e., topped off or filled). Historical data of the oil level data may include a time at which the oil was last replenished, the historical level of oil within oil sump 110, and the historical temperature of oil within oil sump 110. In some aspects, the time(s) of oil changes and/or oil top offs may be derived from data received from oil level sensor 120, as described below. Duty cycle data 218 may include power output information of engine 102, such as power output over time, average power output, cumulative total power output, etc. Duty cycle data 218 may be continuously and/or intermittently gathered from an ECM controlling engine 102.

Control system 200 may provide output 220 from controller 202 in the form of oil high alert 222, oil low alert 224, oil consumption information 226, and oil fill schedule 228. Output 220, in the form of these alerts or otherwise, may be output to a user interface, such as a graphical user interface, or a dashboard. An operator or user of the dashboard seeing the alerts, for example, may then take subsequent action. Oil high alert 222 may be generated and output by controller 202 in response to oil level sensor 120 detecting that the oil in oil sump 110 is abnormally high, e.g., at or above high oil level 116 (see FIG. 1). Oil low alert 224 may be generated and output by controller 202 in response to oil level sensor 120 detecting that the oil in oil sump 110 is abnormally low, e.g., at or below low oil level 114 (see FIG. 1).

Oil consumption information 226 may include a rate of oil consumption of engine 102, i.e. the rate at which oil is lost from engine oil system 100 during operation of engine 102. In some aspects, oil consumption information may be expressed as a rate of oil loss over time or as a rate of oil loss relative to power output of engine (in units such as grams-per-kilowatt-hour). In some aspects, oil consumption information 226 may be continuously updated and output by controller 202 to reflect the current rate of oil consumption. In some aspects, oil consumption information may include an oil consumption alert if the rate of oil consumption exceeds a predetermined threshold, such as an expected rate of oil consumption during normal operation of engine 102.

Oil fill schedule 228 may include a date or range of dates at which controller 202 estimates that the oil will need to be replenished, based on the oil consumption information 226 and/or the power output of engine 102 (see FIG. 1).

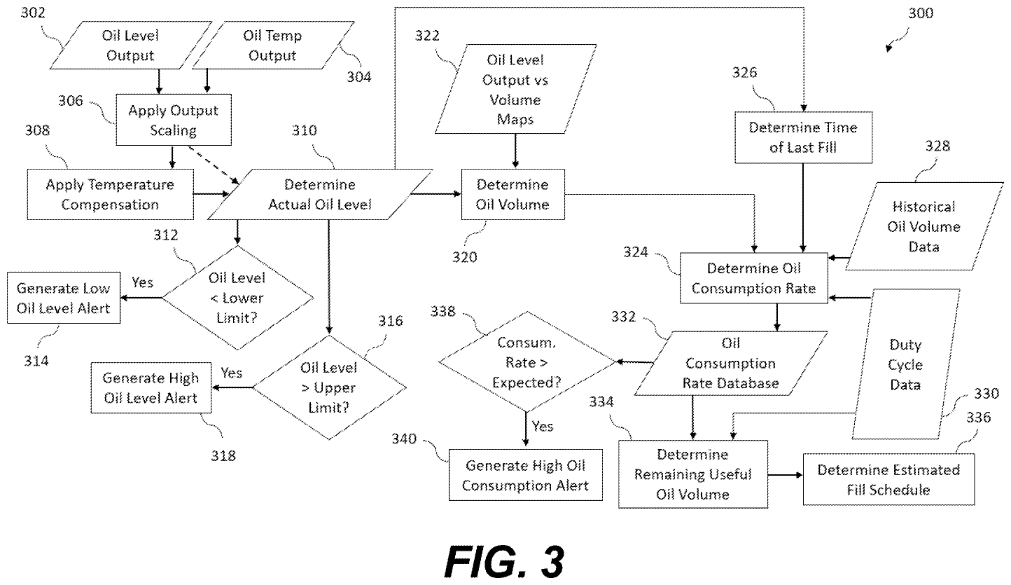

Controller 202 may include memory 240 and one or more processors 245. Memory 240, and/or a secondary storage device associated with controller 202, may store data and/or software instructions that may assist controller 202 in performing various functions, such as the functions of method 300 of FIG. 3. Further, memory 240 and/or secondary storage device associated with controller 202 may also store data received from the various inputs 210, and data generated by controller 202 in response to inputs 210. Processor 245 may be configured to execute the software instructions. Numerous commercially available processors can be configured to perform the functions of processor 245. It should be appreciated that controller 202 could readily embody as a general machine controller capable of controlling numerous other machine functions. Alternatively, a special-purpose machine controller could be provided.

### INDUSTRIAL APPLICABILITY

Engine oil system 100 of the present disclosure may be utilized during the service life of engine 102 to monitor the health and/or life of oil system, including detecting anomalies that indicate failure of certain engine component(s). For example, measuring the volume of oil, oil leaks, loss of oil, high oil levels, and low oil levels may provide indicators of the health and/or life of the oil system and failure of certain engine component(s). Referring again to FIG. 1, oil level of oil sump 110 is desirably maintained within ideal range 112 to prevent adverse effects on engine. For example, low oil level 114 may correspond to an oil volume within oil sump 110 at which engine oil system 100 is unable to maintain a desired oil pressure. High oil level 116 may correspond to an oil volume within oil sump 110 at which crankshaft (not shown) of engine contacts oil in oil sump 110 and causes aeration of the oil. Engine 102 may have recommended oil change intervals which may be based on various factors such as running time of engine, average and/or cumulative power output of engine, and distance traveled (in applications in which engine 102 is provided on a mobile machine). Additionally, engine 102 may have a predetermined acceptable rate of oil consumption. The acceptable rate of oil consumption may account for expected oil losses during normal operation of engine, such as normal rates of oil burn off, loss of oil through the turbocharger, etc. Other sources of oil loss may indicate excess wear and/or component failure of engine. For example, a sudden spike in oil consumption rate may be indicative of a piston ring failure allowing oil to enter the combustion chamber.

FIG. 3 includes a flow chart for an exemplary method 300 for monitoring oil health in engine 102 of FIG. 1. Method 300 includes, at step 302, receiving an oil level output signal. The oil level output signal may be, for example, an electrical output signal of oil level sensor 120 (see FIG. 1). Method 300 may further include, at step 304, receiving a temperature output signal. The temperature output signal may be, for example, an electrical output signal of oil temperature sensor 130 (see FIG. 1). Method 300 may further include, at step 306, applying output scaling to one or both the oil level output and/or oil temperature output received at steps 302 and 304, respectively. The output scaling may include any processing and/or filtering of the oil level output signal and/or oil temperature output signal to create a usable electrical signal. Method 300 may further include, at step 308, applying temperature compensation to the oil level output signal. Temperature compensation may be performed by applying the oil temperature output signal to the oil level output signal to normalize the oil level output signal based on the temperature of the oil. That is, the temperature compensation of step 308 may correct for any influence of temperature on the signal generated by oil level sensor 120. In some embodiments, the method 300 may not include step 308 of applying temperature compensation to the oil level output signal, in which case, the method proceeds from step 306 to step 310, as indicated by the dashed arrow between step 306 and step 310 in FIG. 3. At step 310, the actual oil level is determined based on the temperature compensation being applied to the oil level output signal at step 308. Thus, the actual oil level determined at step 310 is reflective of the oil level in oil sump 110 (see FIG. 1).

After the actual oil level in oil sump 110 has been determined, method 300 may proceed, in some aspects, to steps 312 and/or step 316. At step 312, method 300 includes determining whether the oil level is less than a lower limit. For example, step 312 may include determining whether the oil level in oil sump 110 is below low oil level 114 (see FIG. 1). If the oil level is less than the lower limit, method 300 may proceed to step 314, which includes generating a low oil level alert. In some aspects, the low oil level alert may include a message displayed to an operator of the machine, indicating that the oil level is low and/or suggesting corrective action (e.g. shut down machine, top off oil). In some aspects, the low oil level alert may include a command to a controller of the machine, e.g. controller 202, that causes the machine to perform an action such as shutting down, displaying a warning indictor (e.g. a light or message), limiting output, or performing another action to address the low oil level.

Similar to step 312, at step 316, method 300 includes determining whether the oil level is greater than an upper limit. For example, step 316 may include determining whether the oil level in oil sump 110 is above high oil level 116 (see FIG. 1). If the oil level is greater than the upper limit, method 300 may proceed to step 318, which includes generating a high oil level alert. In some aspects, the high oil level alert may include as message displayed to an operator of the machine, indicating that the oil level is high and/or suggesting corrective action (e.g. shut down machine, drain excess oil). In some aspects, the high oil level alert may include a command to a controller of the machine, e.g. controller 202, that causes the machine to perform an action such as shutting down, displaying a warning indictor (e.g. a light or message), limiting output, or performing another action to address the low oil level.

With continued reference to FIG. 3, method 300 may include, at step 320 determining an oil volume in oil sump 110. Oil volume may be determined based on the actual oil level determined at step 310. In some aspects, determining the oil volume at a step 320 may additionally be based on one or more oil level output vs. volume maps 322. Oil level output vs. volume map 322 may include data (e.g. a table) correlating the actual oil level determined at step 310 to the volume of oil in oil sump 110. Thus, the actual oil volume in oil sump 110 can be derived from the oil level determined at step 310.

Method 300 may further include, at step 324, determining an oil consumption rate of engine 102 (see FIG. 1). The oil consumption rate is a measurement of the volume of oil lost during operation of engine 102 over time. A certain amount of oil consumption may be expected during normal operation of the engine 102. For example, some oil may burn off, and some oil may be lost through a turbocharger (not shown). In some aspects, oil consumption beyond this expected loss may be an indicator of excess wear and/or mechanical problems with the engine, such as an oil leak or a cracked piston ring. Oil consumption rate may be derived from various factors, namely the oil volume determined at step 320, a time of last oil fill determined at step 326, and historical oil volume since last fill received at step 328. Determining the time of last oil fill at step 326 may be based, at least in part, on the actual oil level determined at step 310. For example, if actual oil level determined at step 310 is significantly greater than a previously determined oil level, the oil has been filled (e.g. topped off) more recently than the time of determining the previous oil level. The previously determined oil levels may be obtained from a database (e.g., a server connected to network 150 of FIG. 1 and/or memory 240 of control system 200, shown FIG. 2, if memory 240 is capable of storing such data therein) of historical oil volume data 328, which includes oil levels and associated time stamps of each occurrence of an oil fill event (e.g., oil changes and top offs). Each time an oil fill is determined at step 326, historical oil volume data 328 may be updated to include the oil volume and associated time at which the oil fill occurred.

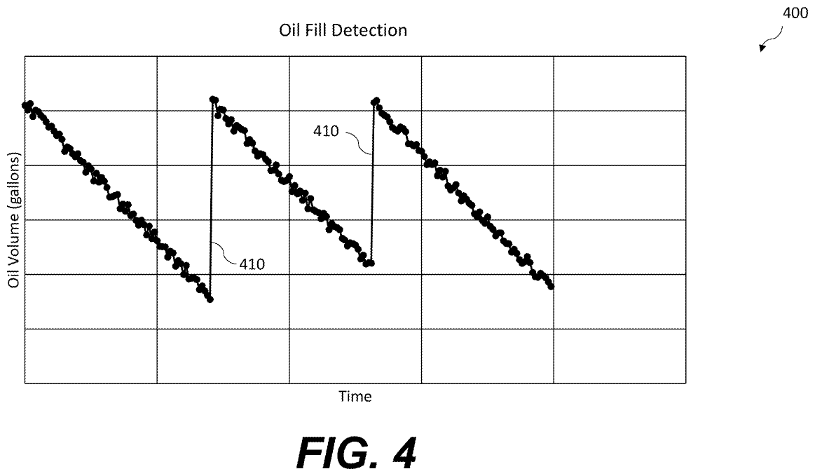

FIG. 4 illustrates an exemplary graph 400 showing oil volume in oil sump 110 (see FIG. 1) as a function of time. Each data point on graph 400 represents one oil volume measurement of the oil in oil sump 110 (e.g., a determination of oil volume from step 320). Oil volume generally decreases over time as a result of normal oil consumption of the engine 102. Increases in the oil volume are thus indicative of oil being added to engine oil system 100. For example, spikes 410 of graph 400 indicate oil fill events (e.g., top offs). Each of these oil fill events may be added to historical oil volume data 328 for use in future iterations of method 300.

Referring again to FIG. 3, determining oil consumption rate at step 324 may be further based on duty cycle data 330. Duty cycle data 330 may include various metrics of engine output, such as power output, run hours, or distance traveled. For example, duty cycle data 330 may include a cumulative power output of engine 102 since a previous oil fill event, a total number of operational hours since a previous oil fill event, a total amount of distance traveled since a last oil fill event, or combination thereof. In applications such as that of a rail locomotive, engine 102 may be operable on a plurality of predetermined power output levels, e.g., high power, medium power, and low power. Duty cycle data 330 may include a run time associated with each power outlet level. For example, duty cycle data 330 may include that engine was operated at high power for a first time interval, followed by low power for a second time interval. Duty cycle data 330 may be continued gathered (e.g., gathered at predetermined intervals during operation of engine 102) by controller 202 (e.g., as duty cycle data 218 of FIG. 2) and stored, such as on a server connected to network 150 of FIG. 1 or on memory 240 of controller 202.

With continued reference to FIG. 3, method 300 may further include storing the oil consumption rate determined at step 324 in an oil consumption rate database 332 each time step 324 is performed. Oil consumption rate database may 332 thus includes time-stamped values of oil consumption rates over the life of engine 102. These values may be analyzed to identify trends and/or problems with engine oil system 100, as will be described in connection with the following steps of method 300.

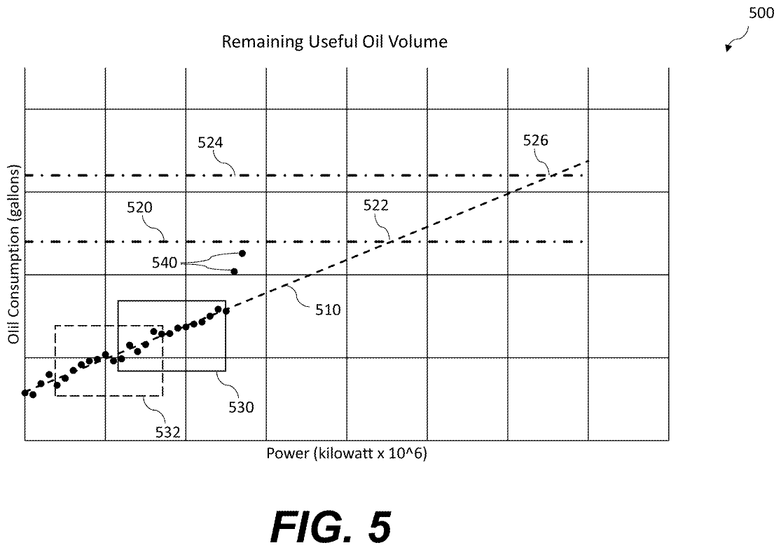

With continued reference to FIG. 3, method 300 may include, at step 334, determining the remaining useful oil volume based on the oil consumption rate(s) stored in oil consumption rate database 332. For example, the remaining useful oil volume may be the volume of oil in oil sump 110 above low oil level 114 (see FIG. 1). The remaining useful oil volume may additionally be based on duty cycle data 330. FIG. 5 shows a graph 500 of oil consumption (on the y-axis) plotted against engine power (on the x-axis). Each data point on graph 500 is an (x, y) pair, with “x” corresponding to cumulative oil consumption (from oil consumption rate database 332) and “y” corresponding to the cumulative power output of the engine (from duty cycle data 330) at the time the corresponding oil consumption rate was measured. Graph 500 may include a trend line 510 modeling the relationship, such as a regression analysis, between the data points. In particular, trend line 510 may have a slope that fits the data points of graph 500. As is evident from graph 500, cumulative oil consumption generally increases with cumulative power output, until oil is refilled or replenished (not show in FIG. 5).

Referring again to FIG. 3, method 300 may include, at step 336, determining an estimated fill schedule for the oil. The estimated oil fill schedule may include one or more dates (or range of dates) at which engine oil system 100 should be replenished or refilled (e.g., topped off). The estimated oil fill schedule may be based on the remaining useful oil volume determined at step 334, as described below. Referring again to FIG. 5, data from graph 500 may be used to estimate the oil fill schedule. A first low oil line 520 may correspond to a cumulative oil consumption volume at which the oil level in oil sump 110 reaches low oil level 114 (see FIG. 1). An intersection 522 of first low oil line 520 with trend line 510 corresponds to the estimated date at which oil will need to be added to prevent the oil level from falling below low oil level 114. As shown in FIG. 5, trend line 510 may be fit to existing data points and may be used to extrapolate future data points to estimate the oil fill schedule. Trend line 510 may be periodically recalculated (e.g., each time a new data point for oil consumption rate is determined at step 324), thereby causing trend line 510 to be a more accurate extrapolation for estimating the oil fill schedule. As such, the intersection of trend line 510 with first low oil line 520 may change as new data is collected, resulting in a change to the estimated oil fill schedule.

Graph 500 may further include a second low oil line 524 corresponding to a cumulative oil consumption volume at which the oil level in oil sump 110 (see FIG. 1) is sufficiently low to cause an oil pressure drop in engine. An intersection 526 of second low oil line 524 with trend line 510 corresponds to the estimated date at which oil consumption will result in an oil pressure drop if the oil is not refilled. If oil is not added by the date associated with intersection 526, an oil pressure drop may occur potentially resulting adverse effects to engine 102, such as insufficient oil which may cause detrimental effects to one or more engine components, such as bearings.

With continued reference to FIG. 5, in some aspects, trend line 510 may be periodically recalculated within a moving window such that only the most recently collected subset of data points are included in calculation of trend line 510. For example, trend line 510 may be generated using only the data points contained in a current window 530, such that oil consumption data collected prior to current window 530 does not contribute to (or provides less contribution to) calculation of trend line 510. Each time a new data point is generated in oil consumption rate database 332, current window 530 shifts to include the new data point. For example, a previous window 532 may include a first subset of data points, but, once new data points are added, current window 530 is generated to encompass a second subset of data points, which includes the new data points and excludes one or more older data points encompassed by previous window 532. As such, the slope of trend line 510 is continually updated to reflect the most recently collected data and thus reflect the most recent operation conditions of engine 102.

Referring again to FIG. 3, method 300 may include, at step 338, determining if the oil consumption rate is greater than expected, i.e. whether the rate of oil consumption meets or exceeds a predetermined threshold. The actual oil consumption rate determined at step 324 and stored in oil consumption rate database 332 (or in memory 240 of control system 200) is compared to the expected oil consumption rate. This is visualized in FIG. 5, with data points 540 exhibiting a significant increase in oil consumption relative to trend line 510. The increase in oil consumption represented by data points 540 indicates an unexpected loss of oil, such as caused by a leak or component failure. In some aspects, an oil consumption rate above the predetermined threshold, e.g. a predetermined number of standard deviations above the expected oil consumption, may indicate a component failure.

With continued reference to FIG. 3, method 300 may include, at step 340, generating a high oil consumption alert if the actual oil consumption rate exceeds the predetermined threshold, i.e. a predetermined deviation above the expected oil consumption rate (as determined at step 338). In some aspects, the high oil consumption alert may include a message displayed to an operator of the machine, such as in a user interface or dashboard, indicating that the oil consumption rate is greater than expected and/or suggesting corrective action (e.g. shut down machine). In some aspects, the high oil consumption alert may include a command to a controller of the machine (e.g. controller 202 of FIG. 2) that causes engine 102 to perform an action responsive to the high oil consumption, such as shut down engine 102, displaying a warning indictor (e.g. a light or message), limiting output of engine 102.

The systems and methods of the present disclosure provide dynamic and real-time monitoring of oil health of engine oil system 100 of FIG. 1, including oil level, time of refills, and oil consumption rates. Using the systems and methods of the present disclosure, an operator and/or ECM of engine 102 may be alerted when the oil level in oil sump 110 is too high (at or above high oil level 116) or too low (at or below low oil level 114), or if oil is consumed at an excessive rate indicating leakage or component failure (e.g., a broken piston ring). Further, the operator and/or ECM may be provided with an accurate estimated oil fill schedule based on various factors such as oil consumption and duty cycle data of engine. Further, the estimated oil fill schedule may be updated as additional data is gathered, so oil top offs or refills may be scheduled based on the current use conditions and oil consumption of engine 102.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A method for determining engine oil system health, the method comprising:
determining an oil level in an engine oil sump of an engine;
determining an oil consumption rate of the engine based on a current oil volume and a time at which the oil was last replenished;
determining a remaining useful oil volume based on the oil consumption rate and duty cycle data of the engine; and
generating an alert in response to the oil consumption rate being greater than a predetermined threshold, the alert comprising a command to a controller associated with the engine to cause the engine to perform an action.

2. The method of claim 1, further comprising:
determining the time at which the oil was last replenished based on an increase in the current oil volume relative to a previous oil volume.

3. The method of claim 1, wherein the determining the remaining useful oil volume is further based on historical data of oil levels.

4. The method of claim 1, wherein the alert is output to a user interface.

5. The method of claim 1, wherein the predetermined threshold corresponds to a deviation above an expected oil consumption rate.

6. The method of claim 5, wherein the duty cycle data comprises at least one of power output of the engine, run time of the engine, or distance traveled of a mobile machine including the engine.

7. The method of claim 1, wherein the remaining useful oil volume corresponds to a volume of oil in the engine oil sump above a low oil level below which the engine is unable to maintain a desired oil pressure.

8. The method of claim 1, further comprising determining an estimated fill schedule for the oil.

9. The method of claim 8, wherein the estimated fill schedule comprises a date or range of dates at which the oil level is estimated to fall below a predetermined level.

10. The method of claim 9, wherein the predetermined level corresponds to a low oil level below which the engine is unable to maintain a desired oil pressure.

11. A system for monitoring engine system oil health, the system comprising:
an oil sump of an engine;
an oil level sensor for determining oil level in the oil sump; and
a controller configured to:
determine an oil fill schedule based at least partially on the oil level,
wherein the oil fill schedule includes a date or range of dates at which oil in the oil sump should be replenished.

12. The system of claim 11, further comprising a temperature sensor for determining a temperature of the oil in the oil sump, wherein the controller is configured to apply temperature compensation to an output signal of the oil level sensor based on the temperature of the oil.

13. The system of claim 11, wherein the controller is further configured to determine a useful oil volume of the oil based on duty cycle data and an oil consumption rate.

14. The system of claim 11, wherein the controller is configured to determine a time of last oil fill based on the oil level.

15. The system of claim 11, wherein the controller is further configured to determine where an oil consumption rate exceeds a predetermined threshold corresponding to expected oil consumption during normal operation of the engine.

16. The system of claim 11, wherein the oil level sensor is a capacitive oil level sensor.

17. A method for determining an estimated fill schedule for an engine oil system, the method comprising:
determining an oil level in an engine sump of an engine;
determining an oil volume in the engine sump based on the oil level;
determining an oil consumption rate of the engine based on the oil volume; and
determining an estimated fill schedule for the oil based on the oil consumption rate.

18. The method of claim 17, wherein the estimated fill schedule comprises a date or range of dates at which the oil level is estimated to fall below a predetermined level.

19. The method of claim 18, wherein determining the estimated fill schedule comprises extrapolating from oil consumption data over a current window of data points.

20. The method of claim 19, further comprising shifting the current window to include new collected data points and to exclude at least one data point from a previous window.
